(19) United States
(12) Patent Application Publication
(10) Pub. No.: US 2020/0081892 A1
(43) Pub. Date: Mar. 12, 2020

(54) APPLET MANAGEMENT DEVICE AND METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: CHANG-GEN YE, Shenzhen (CN)

(21) Appl. No.: 16/222,003

(22) Filed: Dec. 17, 2018

(30) Foreign Application Priority Data
Sep. 12, 2018 (CN) 201811064665.3

(51) Int. Cl. G06F 16/2457; G06F 16/28; G06F 16/9035

(52) U.S. Cl. CPC G06F 16/24573; G06F 16/9035; G06F 16/24578; G06F 16/285

(57) ABSTRACT

An applet management device includes a processor and a memory. The memory stores a number of applets. The applet management device obtains a function description of an applet uploaded by a user, classifies the applet according to the function description, and saves the classified applet in the memory.

### FIELD

The subject matter herein generally relates to applets, and more particularly to a method for managing applets.

### BACKGROUND

Applets are mini-programs or software code executed within an application in an electronic device. When a developer develops an applet, a target user of the applet needs a way to find the applet.

### BRIEF DESCRIPTION OF THE DRAWINGS

Implementations of the present disclosure will now be described, by way of embodiments, with reference to the attached figures.

FIG. 1 is a block diagram of an embodiment of an applet management device implementing an applet management system.

FIG. 2 is a block diagram of an upload interface of an applet management interface of the applet management device.

FIG. 3 is a block diagram of a download interface of the applet management interface.

FIG. 4 is a flowchart of a method for managing applets.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

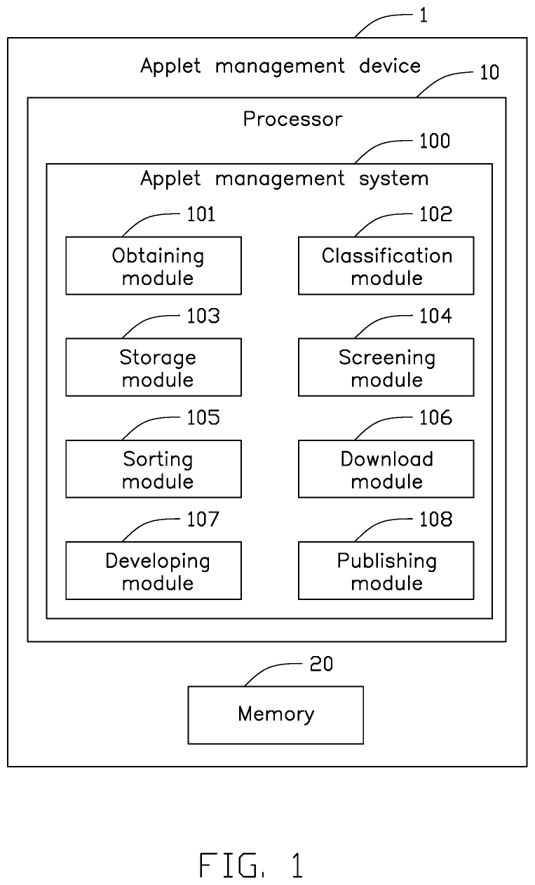

FIG. 1 shows an embodiment of an applet management device 1 adapted for managing a plurality of applets, allowing an applet developer to upload a new applet, and allowing a user to download an applet. As used herein, the term “applet” refers to an application or script that does not need to be installed.

The applet management device 1 includes a memory 20 and a processor 10. The memory 20 may include, but is not limited to, a read-only memory, a random access memory, a programmable read-only memory, an erasable programmable read-only memory, a one-time programmable read-only memory, an electrically-erasable programmable read-only memory, an electrically-erasable programmable read-only memory, a compact disc read-only memory, or other optical storage disk, magnetic storage disc, or magnetic storage tape. The memory 20 stores the plurality of applets.

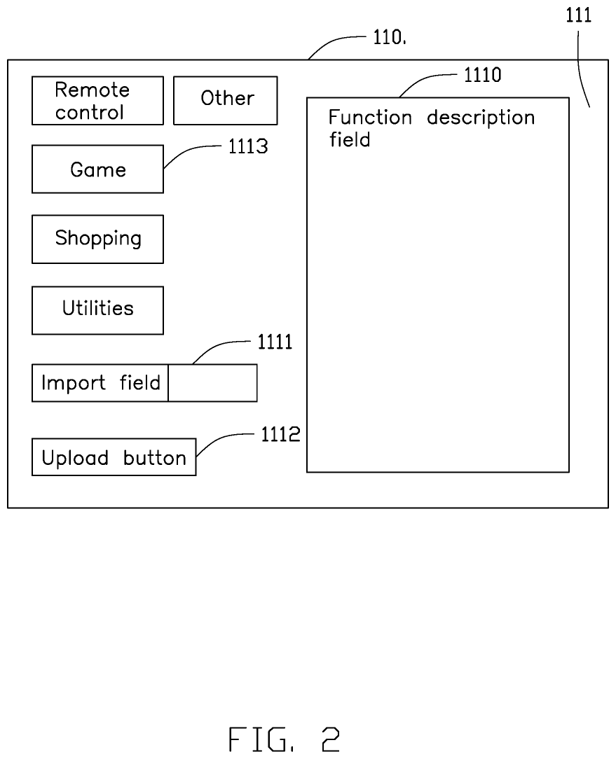

As shown in FIGS. 1 and 2, the applet management device 1 implements an applet management system 100. A user logs into the applet management system 100 to upload or download an applet. The applet management system 100 provides an applet management interface 110 for uploading or downloading an applet.

As shown in FIG. 1, the applet management system 100 includes at least an obtaining module 101, a classification module 102, a storage module 103, a screening module 104, a sorting module 105, a download module 106, a developing module 107, and a publishing module 108. In one embodiment, the modules 101-108 can include one or more software programs in the form of computerized codes stored in the memory 20. The computerized codes can include instructions executed by the processor 10 to provide functions for the modules 101-108. In other embodiments, the modules 101-108 may be integrated with the processor 10.

The obtaining module 101 obtains a function description of an applet when the applet is uploaded by a user.

Specifically, as shown in FIG. 2, the applet management interface 110 includes an upload interface 111. When the user uses a developer account to log into the applet management system 100, the applet management interface 110 provides the upload interface 111. In one embodiment, the upload interface 111 includes a function description field 1110, an import field 1111, and an upload button 1112.

Before uploading the applet in the upload interface 111, the user inputs a function description of the applet in the function description field 1110. In one embodiment, the function description includes keywords or phrases. For example, the function description of a gaming application may include the keywords “online game”, “tower defense”, “free”, or the like, and the function description of a remote control application of a toy car may include the phrases “sending control commands by phone, such as going forward, reversing, turning left, turning right, and so on”, “BLUETOOTH control of toy car”, or the like.

The import field 1111 allows the user to input a configuration file of the applet. The upload button 1112 is selected to upload the applet. The obtaining module 101 obtains the function description from the function description field 1110 when the upload button 1112 is selected.

The classification module 102 classifies the applet according to the function description.

In one embodiment, the applet management system 100 provides a plurality of predetermined type selections either before or after the applet is uploaded. The classification module 102 confirms the type of the applet according to the predetermined type selection selected by the user. The plurality of predetermined type selections includes at least “remote control”, “game”, “utilities”, “shopping”, and “other”. In one embodiment, the applet management interface 110 may include type selections 1113. The user can select one or more of the type selections 1113 before uploading the applet. In another embodiment, the user can select one or more of the type selections 1113 after uploading the applet. For example, after the applet is uploaded, the type selections 1113 are provided in a pop-up window (not shown).

In another embodiment, the classification module 102 analyzes the function description and determines the type of the applet according to the function description. For example, if the function description includes the keywords “online game”, “tower defense”, and “free”, the keywords are determined to be descriptors of a game. If the function description includes the phrases “sending control commands by phone” and “BLUETOOTH control of toy car”, the phrases are determined to be descriptors of a remote control application of a toy car.

The storage module 103 stores the classified applets in the memory 20.

In one embodiment, the memory 20 includes a plurality of storage areas. Each storage area stores the same type of applets. The storage module 103 stores the classified applets in the corresponding storage areas according to the types of the applets.

The screening module 104 filters the plurality of applets according to a filter condition input by the user.

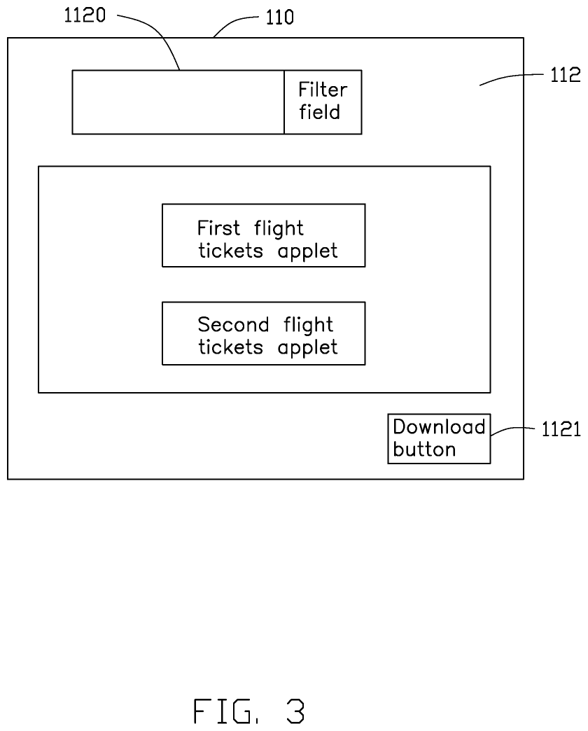

As shown in FIG. 3, in one embodiment, a user can use a normal account to log into the applet management system 100. The applet management interface 110 displays a download interface 112. The user can download an applet in the download interface 112.

Specifically, the download interface 112 includes a filter field 1120 and a download button 1121. When the user inputs a filter condition and selects the download button 1121, the screening module 104 filters the plurality of applets in the memory 20 according to the filter condition. In one embodiment, the filter condition includes at least an applet type and function description. For example, the user inputs the filter condition as “game”, and the filter description includes the keywords “tower defense” and “free”.

The sorting module 105 sorts the plurality of applets according to the filter condition.

In one embodiment, the user can input one or more keywords. The sorting module 105 compares the keywords to the filtered applets. The sorting module 105 sorts the filtered applets in order from a highest relevance to a lowest relevance according to a quantity of the keywords matching the applet. As shown in FIG. 3, the keywords “flight tickets” and “points” return the filter results for a first flight tickets applet and a second flight tickets applet. The function description of the first flight tickets applet includes “domestic and international flight tickets and points rewards services”, and the function description of the second flight tickets applet includes “domestic and international flight tickets and date search”. Because the function description of the first flight tickets applet matches more keywords than the second flight tickets applet, the first flight tickets applet is arranged first before the second flight tickets applet.

The download module 106 downloads the filtered applets to an electronic device of the user.

In one embodiment, when the screening module 104 filters an applet, the download module 106 directly downloads the filtered applet to the electronic device. When the screening module 104 filters more than one applet, the download module 106 downloads the first applet having the highest relevance sorted by the sorting module 105. In other embodiments, the user can manually select one of the applets filtered and selecting the download button 1121 to download the selected applet.

The developing module 107 receives the applet developed by an applet development template and a development interface used by a user. In one embodiment, the applet management system 100 provides a plurality of applet development templates and development interfaces. Each predetermined type of applet corresponds to a plurality of development templates. Thus, a user can easily develop an applet in the development interface. In one embodiment, the applet development template uses JAVA or PHP script.

The publishing module 108 publishes the applet developed with the development template in the development interface. In one embodiment, after an applet is developed by a user in the development interface, the publishing module 108 can check the applet for errors. After the applet is checked, the applet is published to be downloaded by another user.

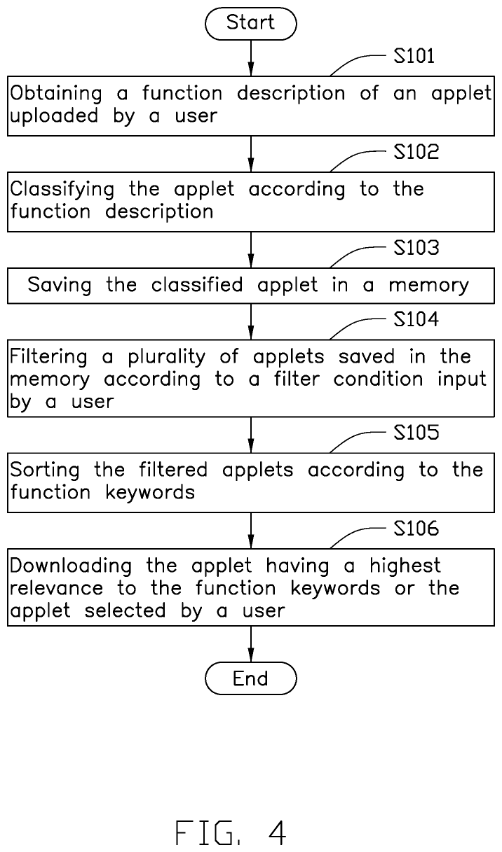

FIG. 4 illustrates a flowchart of a method for managing applets. The method is provided by way of example, as there are a variety of ways to carry out the method. The method described below can be carried out using the configurations illustrated in FIGS. 1-3, for example, and various elements of these figures are referenced in explaining the method. Each block shown in FIG. 4 represents one or more processes, methods, or subroutines carried out in the method. Furthermore, the illustrated order of blocks is by example only, and the order of the blocks can be changed. Additional blocks can be added or fewer blocks can be utilized, without departing from this disclosure. The method can begin at block S101.

At block S101, a function description of an applet uploaded by a user is obtained.

At block S102, the applet is classified according to the function description.

At block S103, the classified applet is saved in the memory 20.

At block S104, the plurality of applets saved in the memory 20 are filtered according to a filter condition input by a user. The filter condition includes at least a type and function keywords of the applet.

At block S105, the filtered applets are sorted according to the function keywords.

At block S106, the applet having a highest relevance to the function keywords or the applet selected by a user is downloaded.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An applet management device comprising:
a processor; and
a memory storing a plurality of applets and a plurality of instructions, which when executed by the processor, cause the processor to;
obtain a function description of an applet uploaded by a user;
classify the applet according to the function description; and
save the classified applet in the memory.

2. The applet management device of claim 1, wherein the processor is further caused to:
filter the plurality of applets saved in the memory according to filter conditions input by a user, the filter conditions comprising at least a type and function keywords of the applet; and
download a filtered one of the applets to an electronic device of the user.

3. The applet management device of claim 2, wherein the processor is further caused to:
provide an applet management interface after a user logs into the applet management device; wherein:
the applet management interface comprises an upload interface and a download interface;
the upload interface allows a user to input a configuration file and the function description of the applet; and
the download interface allows a user to input filter conditions and download the applet.

4. The applet management device of claim 2, wherein the processor is further configured to:
sort the filtered applets by relevancy according to keywords input by a user when more than one applet is filtered by the filter conditions; and
download the applet having a highest relevancy according to the keywords or the applet selected by a user.

5. The applet management device of claim 2, wherein:
the memory comprises a plurality of storage areas;
each of the storage areas stores a same type of applets; and
the applet is stored in the corresponding storage area of the memory according to the type of the applet.

6. The applet management device of claim 1, wherein the processor is further configured to:
receive the applet developed by a development interface and a development template used by a user; and
publish the applet developed by the development interface and the development template used by the user.

7. An applet management method implemented in an applet management device comprising a memory storing a plurality of applets, the method comprising:
obtaining a function description of an applet uploaded by a user;
classifying the applet according to the function description; and
saving the classified applet in the memory.

8. The applet management method of claim 7 further comprising:
filtering the plurality of applets saved in the memory according to filter conditions input by a user, the filter conditions comprising at least a type and function keywords of the applet; and
downloading a filtered one of the applets to an electronic device of the user.

9. The applet management method of claim 8 further comprising:
providing an applet management interface after a user logs into the applet management device; wherein:
the applet management interface comprises an upload interface and a download interface;
the upload interface allows a user to input a configuration file and the function description of the applet; and
the download interface allows a user to input filter conditions and download the applet.

10. The applet management method of claim 8 further comprising:
sorting the filtered applets by relevancy according to keywords input by a user when more than one applet is filtered by the filter conditions; and
downloading the applet having a highest relevancy according to the keywords or the applet selected by a user.

11. The applet management method of claim 8, wherein:
the memory comprises a plurality of storage areas;
each of the storage areas stores a same type of applets; and
the applet is stored in the corresponding storage area of the memory according to the type of the applet.

12. The applet management method of claim 7 further comprising:
receiving the applet developed by a development interface and a development template used by a user; and
publishing the applet developed by the development interface and the development template used by the user.

13. A non-transitory storage medium comprising a memory having stored thereon instructions that, when executed by at least one processor of an applet management device, causes the at least one processor to execute instructions of an applet management method, the method comprising:
obtaining a function description of an applet uploaded by a user;
classifying the applet according to the function description; and
saving the classified applet in the memory.

14. The non-transitory storage medium of claim 13, wherein the method further comprises:
filtering the plurality of applets saved in the memory according to filter conditions input by a user, the filter conditions comprising at least a type and function keywords of the applet; and
downloading a filtered one of the applets to an electronic device of the user.

15. The non-transitory storage medium of claim 14, wherein the method further comprises:
providing an applet management interface after a user logs into the applet management device; wherein:
the applet management interface comprises an upload interface and a download interface;
the upload interface allows a user to input a configuration file and the function description of the applet; and
the download interface allows a user to input filter conditions and download the applet.

16. The non-transitory storage medium of claim 14, wherein the method further comprises:
sorting the filtered applets according to keywords input by a user when more than one applet is filtered by the filter conditions; and
downloading the applet having a highest relevancy according to the keywords or the applet selected by a user.

17. The non-transitory storage medium of claim 13, wherein:
the memory comprises a plurality of storage areas;
each of the storage areas stores the same type of applets; and
the applet is stored in the corresponding storage area of the memory according to the type of the applet.

18. The non-transitory storage medium of claim 13, wherein the method further comprises:
receiving the applet developed by a development interface and a development template used by a user; and
publishing the applet developed by the development interface and the development template used by the user.
